(19) United States
(12) Patent Application Publication
(10) Pub. No.: US 2026/0151903 A1
(43) Pub. Date: Jun. 4, 2026

(54) METHOD FOR CONTROLLING A ROBOT DEVICE USING A CONDITIONAL INVERTIBLE NEURAL NETWORK MODEL

(71) Applicant: Robert Bosch GmbH, Stuttgart (DE)

(72) Inventors: Karim Said Mahmoud Barsim, Stuttgart (DE); Siddieq Mansour, Stuttgart (DE)

(21) Appl. No.: 19/401,769

(22) Filed: Nov. 26, 2025

(30) Foreign Application Priority Data
Dec. 2, 2024 (DE) 10 2024 211 515.0

(51) Int. Cl. B25J 9/16

(52) U.S. Cl. CPC B25J 9/163; B25J 9/161

(57) ABSTRACT

A method for controlling a robot device. The method includes: controlling the robot device in accordance with a respective initial input parameter value of a plurality of input parameters, and determining a respective initial output parameter value of one or more output parameters; determining a plurality of Shapley values by inputting the initial input parameter values as input and the initial output parameter value(s) as condition into a conditional invertible neural network model, wherein each Shapley represents a contribution of a corresponding input parameter to the one or more output parameters; determining a target output parameter value for each output parameter; determining a plurality of target input parameter values by inputting the plurality of Shapley values conditioned on the target output parameter value(s) into an inverse path of the conditional invertible neural network model; and controlling the robot device in accordance with the plurality of target input parameter values.

### CROSS REFERENCE

The present application claims the benefit under 35 U.S.C. § 119 of Germany Patent Application No. DE 10 2024 211 515.0 filed on Dec. 2, 2024, which is expressly incorporated herein by reference in its entirety.

### FIELD

For various technical (e.g., physical or chemical) processes, such as a production process and/or machining process (e.g. drilling, milling, heat treatment, etc.), it may be desired to determine, based on given output parameters of the technical process, input parameters (e.g., a process temperature, a process time, a vacuum or a gas atmosphere, etc.) for controlling the technical process such that the given output parameters (e.g., one or more properties of a process workpiece, such as hardness, strength, thermal conductivity, electrical conductivity, density, microstructure, macrostructure, chemical composition, etc.) are achieved.

To describe a relation between input parameters and output parameters of the technical process, a (black box) Bayesian optimization model may be used which is generated by first learning a probabilistic model using an initial amount of measurement data and then optimizing the probabilistic model using an acquisition function for selecting new measurement points (e.g., being a tradeoff between exploration and exploitation).

However, there are several disadvantages to Bayesian optimization models: The model does not allow to determine whether a specific measurement point is not optimal. Further, the acquisition function has to be optimized, and thus suffers from the common challenges of non-linear optimization. For example, it would be very challenging to optimize a discrete system with such an approach since discrete optimization lacks continuity which in turn challenges application of gradient-based optimization. In reality, an output may be simply a binary variable (pass/fail) representing whether the system was operating as expected e.g., in quality assessment/auditing at the end of a production line. Further, Bayesian optimization does not support instance-based (e.g., context-aware) optimization. Thus, Bayesian optimization allows to determine how to make the system behave optimally, but does not allow to determine what (e.g., minimal) changes have to be applied to the technical system to address existing failures.

### SUMMARY

The present invention relates to a method for controlling a robot device that allows to provide an (e.g., real-time) explanation of system failures, such as to determine which input parameters contribute to what extent to the system failure. Further, the method of the present invention allows to generate input parameters for controlling the robot device that overcome the system failure. Further, the method of the present invention allows to determine these input parameters such that only small (e.g., minimal) changes to the technical system are required in order to prohibit the system failure.

According to an example embodiment of the present invention, this is, for example, achieved by using a conditional invertible neural network model that is configured (e.g., trained) to map input parameters to Shapley values and vice versa as a function of output parameters (by conditioning on the output parameters). With this, the input parameters can be generated by a single pass through the conditional invertible neural network model (as opposed to iterative methods which require multiple iterations), thereby reducing the computation cost required for the control.

Illustratively, the method allows to computationally-efficient generate alternative input parameters (as control inputs) to optimize a given system (e.g., a process chain of a manufacturing pipeline) towards a more desired operational range, given a system failure or undesired output parameter(s) (as observation) in general.

Various aspects of the present invention related to a method for controlling a robot device. According to an example embodiment of the present invention, the method includes: controlling the robot device in accordance with a respective initial input parameter value of each input parameter of a plurality of input parameters, and determining (e.g., detecting) a respective initial output parameter value of each output parameter of one or more (e.g., physical) output parameters resulting from the controlling; determining (e.g., predicting, estimating) a plurality of Shapley values by inputting the respective initial input parameter value of each of the plurality of input parameters as input and the respective initial output parameter value of each of the one or more output parameters as condition into a conditional invertible neural network model, wherein each Shapley value of the plurality of Shapley values is associated with a corresponding input parameter of the plurality of input parameters and represents a contribution of the corresponding input parameter to the one or more output parameters; determining a respective target output parameter value for each of the one or more output parameters, wherein the respective target output parameter value of at least one output parameter of the one or more output parameters is different from the respective initial output parameter value of the at least one output parameter; determining a respective target input parameter value for each of the plurality of input parameters by inputting the plurality of Shapley values conditioned on the respective target output parameter value of each of the one or more output parameters into an inverse path of the conditional invertible neural network model; and controlling the robot device in accordance with the respective target input parameter value of each of the plurality of input parameters.

In the following, various examples of the present invention are described.

Example 1 is the method for controlling a robot device as described above.

In Example 2, the subject matter of Example 1 can optionally include that each input parameter of the plurality of input parameters is a physical parameter, a chemical parameter, or a control parameter.

Thus, an input parameter may be any parameter that is directly or indirectly used to control the robot device. As an illustratively example, the robot device may be a drilling machine controlled to drill a hole. In this example, an input parameter may be a physical parameter, such as a temperature of a cooling liquid, a rotation speed, etc., or may be a control parameter, such as an applied voltage for generating a desired rotation speed. Each output parameter may be a physical parameter, such as, in the above example, a smoothness of the drilled hole, a diameter of the drilled hole, etc.

In Example 3, the method of Example 1 or 2 can optionally further include: for at least one (e.g., each) predefined output parameter of the one or more output parameters: determining, whether the respective initial output parameter value of the at least one predefined output parameter is within a predefined range; and in the case that it is determined that the respective initial output parameter value of the at least one predefined output parameter is not within the predefined range (e.g., thereby detecting an anomaly), determine the respective target output parameter value of the at least one predefined output parameter to be within the predefined range.

Illustratively, this allows to detect, for example, anomalies. For example, the at least one (e.g., each) of the one or more output parameters may be monitored continuously and, in the case that the detected at least one predefined output parameter is different from expectation (e.g., lies outside the predefined range), the value of this at least one predefined output parameter is changed (to the target output parameter value) to meet the expectation (e.g., to lie within the predefined range) and this value is then input into the inverse path of the conditional invertible neural network model to determine new input parameter values that ensure that the at least one predefined output parameter meets the expectation.

In Example 4, the method of any one of Examples 1 to 3 can optionally further include: adapting the plurality of Shapley values prior to inputting them into the inverse path of the conditional invertible neural network model, wherein adapting the plurality of Shapley values includes changing one or more Shapley values of the plurality of Shapley values to zero.

This allows to limit the number of input parameters that are to be changed in order to achieve the target output parameter values, since the Shapley values that are changed to zero indicate that the corresponding input parameter has no contribution to the one or more output parameters.

In Example 5, the subject matter of Example 4 can optionally include that the one or more Shapley values are a predefined number of smallest Shapley values; or wherein the one or more Shapley values are all Shapley values of the plurality of Shapley values equal to or less than a threshold value.

The greater the Shapley value, the less the value of the corresponding input parameter has to be changed to achieve a change of the one or more output parameters. Thus, when inputting these adapted Shapley values into the inverse path of the conditional invertible neural network model, only the input parameters associated with the greater Shapley values are adapted to achieve the target output parameter values. Since the change of these input parameters associated with the greater Shapley values is less than it would be for the other ones, the overall changes to the plurality of input parameters is reduced (e.g., minimized) while still achieving the target output parameter values.

In Example 6, the method of any one of Examples 1 to 5 can optionally further include: adapting the plurality of Shapley values prior to inputting them into the inverse path of the conditional invertible neural network model, wherein adapting the plurality of Shapley values includes changing all Shapley values of the plurality of Shapley values except for the greatest Shapley value to zero.

In this case, only one input parameter value has to be changed in order to achieve the target output parameter values, thereby increasing the effectiveness of the robot device.

Example 7 is a robot device controller configured to carry out the method of any one of Examples 1 to 6.

Example 8 is a technical system including: the robot device controller according to Example 7; the robot device; and one or more sensors configured to acquire the respective initial output parameter value of each of the one or more output parameters.

Example 9 is a computer program including instructions which, when executed by a computer, causes the computer to carry out the method according to any one of Examples 1 to 6.

Example 10 is a computer-readable medium including instructions which, when executed by a computer, causes the computer to carry out the method according to any one of Examples 1 to 6.

In the figures, similar reference characters generally refer to the same parts throughout the different views. The figures are not necessarily to scale, emphasis instead generally being placed upon illustrating the principles of the present invention. In the following description, various aspects of the present invention are described with reference to the figures.

### BRIEF DESCRIPTION OF THE DRAWINGS

FIG. 1 shows a flow diagram of a method of controlling a robot device (using a conditional invertible neural network model) according to various aspects of the present invention.

FIG. 2 shows an exemplary system on which the method can be carried out according to various aspects of the present invention.

FIG. 3 shows an architecture of a conditional invertible neural network model according to various aspects of the present invention.

FIG. 4 shows a process flow of adapting input parameters using the conditional invertible neural network model according to various aspects of the present invention.

FIG. 5 shows a flow diagram of a method of managing system failures, according to an example embodiment of the present invention.

### DETAILED DESCRIPTION OF EXAMPLE EMBODIMENTS

The following detailed description refers to the figures that show, by way of illustration, specific details and aspects of this disclosure in which the present invention may be practiced. Other aspects may be utilized and structural, logical, and electrical changes may be made without departing from the scope of the present invention. The various aspects of this disclosure are not necessarily mutually exclusive, as some aspects of this disclosure can be combined with one or more other aspects of this disclosure to form new aspects.

In the following, various example embodiments of the present invention will be described in more detail.

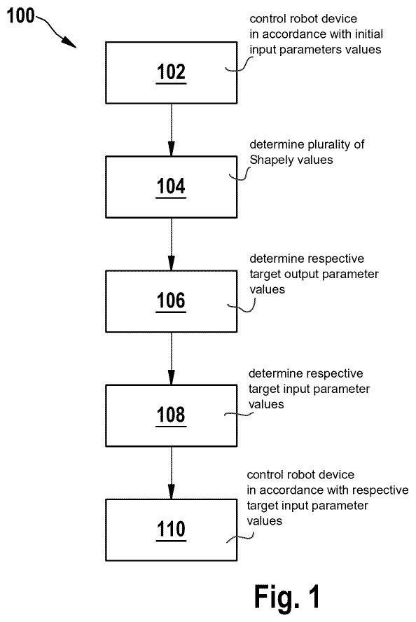

FIG. 1 shows a flow diagram of a method 100 of controlling a robot device according to various aspects.

The method 100 may (in 102) include controlling the robot device in accordance with a respective initial input parameter value of each input parameter of a plurality of input parameters, and determining (e.g., detecting) a respective initial output parameter value of each output parameter of one or more (e.g., physical) output parameters resulting from the controlling.

The method 100 may (in 104) include determining (e.g., predicting, estimating) a plurality of Shapley values by inputting the respective initial input parameter value of each of the plurality of input parameters as input and the respective initial output parameter value of each of the one or more output parameters as condition into a conditional invertible neural network model. Each Shapley value of the plurality of Shapley values may be associated with a corresponding input parameter of the plurality of input parameters. Each Shapley value of the plurality of Shapley values may represent a contribution of the corresponding input parameter to the one or more output parameters.

The method 100 may (in 106) include determining a respective target output parameter value for each of the one or more output parameters. According to various aspects, the respective target output parameter value of at least one output parameter of the one or more output parameters may be different from the respective initial output parameter value of the at least one output parameter.

The method 100 may (in 108) include determining a respective target input parameter value for each of the plurality of input parameters by inputting the plurality of Shapley values conditioned on the respective target output parameter value of each of the one or more output parameters into an inverse path of the conditional invertible neural network model.

The method 100 may (in 110) include controlling the robot device in accordance with the respective target input parameter value of each of the plurality of input parameters.

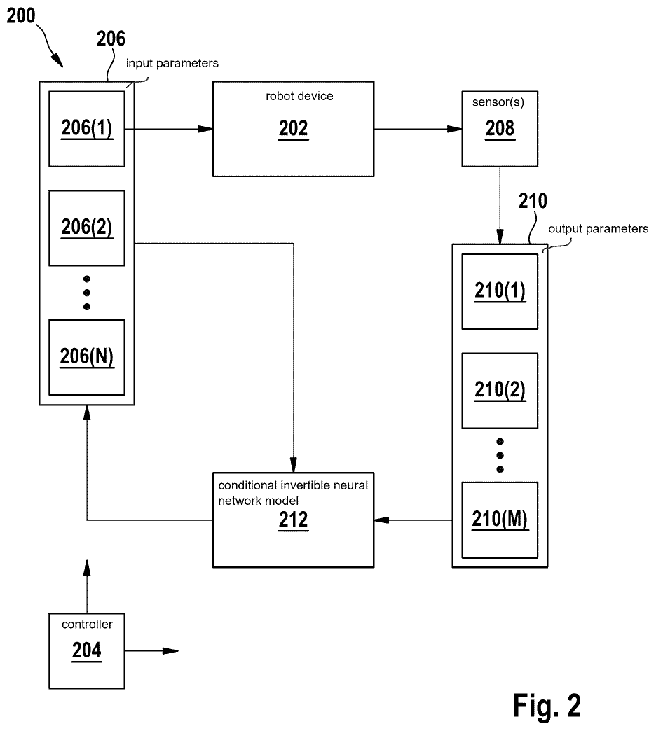

In the following, various aspects of the method 100 are described in further detail with reference to a technical system 200 shown in FIG. 2.

The technical system 200 may include a robot device 202. The robot device 202 may be configured to carry out a technical process. The robot device 202 may be any kind of (computer-controlled) technical device configured to carry out a technical process, such as a robot (e.g., a manufacturing robot, a maintenance robot, a domestic robot, a medical robot, a craft appliance (e.g. a drill), etc.), a vehicle (e.g., an at least partially automated (e.g., autonomous) vehicle), a domestic appliance, a production machine, a personal assistant, an access control system, etc., as well as any other type of robot device.

According to various aspects, the technical process may be a physical or chemical process, such as, for example, a manufacturing process (e.g., manufacturing a product or intermediate product), a machining process (e.g., machining a workpiece), a control process (e.g., moving a robot arm), a setting process (e.g., calibrating a measuring apparatus), etc.

For control of the robot device 202, the technical system 200 may include a robot device controller (short: controller) 204. The controller 204 may be configured to control (an operation of) the robot device 202 (according to a control program). The term “controller” may be understood as any type of logic implementing entity, which may include, for example, a circuit and/or a processor capable of executing software stored in a storage medium, firmware, or a combination thereof, and which can provide instructions, e.g. to an actuator in the present example. The controller may be configured, for example, by program code (e.g., software) to control the operation of the system 200 (e.g., the robot device 202).

The controller 204 may be configured to control the robot device 202 in accordance with a plurality of input parameters 206. Hence, the controller 204 may control the robot device 202 according to a respective input parameter value of each input parameter 206(n) of the plurality of input parameters 206. The plurality of input parameters 206 may include a number of N input parameters, with N being any integer number equal to or greater than two.

An input parameter, as used herein, may be a physical parameter or a chemical parameter or a control parameter or any other kind of parameter describing the technical system 200.

A result of the technical process may be acquired using one or more sensors 208. The one or more sensors 208 may be configured to acquire a respective output parameter value for each output parameter 210(m) of one or more output parameters 210. The one or more one or more output parameters 210 may include a number of M output parameters, with M being any integer number equal to or greater than one.

An output parameter, as used herein, may be a parameter that describes an output of the technical process. An output parameter of the technical process may be a property of a product, workpiece, captured image or other result. The output parameter may have an application-specific quality criterion. The output parameter may be a component-related parameter, such as a dimension or a layer thickness, or may be a material-related parameter, such as hardness, thermal conductivity, electrical conductivity, density, chemical composition, etc.

As an example, the robot device 202 may be a drilling machine controlled to drill a hole. Hence, the technical process may be drilling of a hole. An input parameter 206(n) may, for example, be a physical parameter, such as a temperature of a cooling liquid used during drilling the hole, a rotation speed of a drill bit, etc., or may be a control parameter, such as a voltage applied to a unit of the robot device 202 (e.g., an actuator which is configured to rotate the drill bit according to the applied voltage). An output parameter 210(m) may be, for example, a smoothness of the drilled hole, a diameter of the drilled hole, or any other property of the drilled hole.

As another example, the technical process may be a production or manufacturing process for manufacturing a workpiece carried out in a processing chamber. In this example, an input parameter 206(n) may, for example, be a temperature of the workpiece during the technical process, a voltage applied to an actuator, or a chemical parameter, a concentration or (partial) pressure of a processing gas within the processing chamber, etc. An input parameter may also be another parameter representing the technical process, such as an opening of a valve that is configured to regulate an inlet of the processing gas. Hence, the opening of the valve may indicate a (partial) pressure of the processing gas.

It is understood that these are examples for illustration and that the technical process may be any other kind of technical process, such as another production or machining process (e.g. milling, heat treatment), a technical process of a vehicle as robot device (with an input parameter or an output parameter being e.g., a braking force, a velocity, etc.), etc.

The respective output parameter value of each output parameter 210(m) of the one or more output parameters 210 may be acquired (using the one or more sensors 208) during carrying out the technical process (viz. in-situ) and/or after carrying out the technical process (viz. ex-situ).

Thus, in the example of the technical process being a production or manufacturing process carried out in the processing chamber (viz. in-situ), and the output parameter acquired during the process may be a temperature of the workpiece during manufacturing. As an ex-situ example, the technical process may be a hardening of a workpiece in an oven with a temperature as an input parameter and an output parameter may be a hardness of the workpiece at room temperature after the hardening process.

The controller 204 may be configured to implement a conditional invertible neural network model 212. The controller 204 may be configured to determine, for at least one (e.g., each) output parameter 210(m*) of the one or more output parameters 210, whether the at least one output parameter 210(m*) meets a predefined requirement, such as being within a predefined range. It is understood that a predefined value in combination with a (acceptable) tolerance may also provide a predefined range. The controller 204 may be configured to, in the case that the at least one output parameter 210(m*) does not meet the predefined requirement, adapt the at least one output parameter 210(m*) to meet the predefined requirement (e.g., to be within the predefined range). The controller 204 may be configured to determine, using the conditional invertible neural network model 212, a respective target input parameter value for each input parameter 206(n) of the plurality of input parameters 206 which is expected to result in the adapted output parameter value of the at least one output parameter 210(m*) in the case that the robot device 202 is controlled according to the target input parameter values.

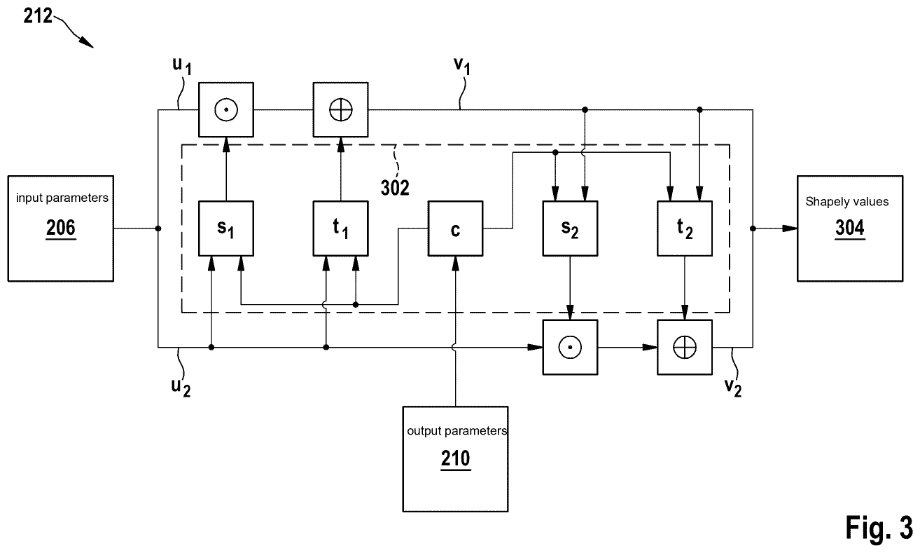

FIG. 3 shows an architecture of the conditional invertible neural network model 212 according to various aspects.

The architecture of the conditional invertible neural network model 212 is, for example, described in L. Ardizzone et al.: “GUIDED IMAGE GENERATION WITH CONDITIONAL INVERTIBLE NEURAL NETWORKS”, arXiv: 1907.02392, 2019 (in the following referred to as reference [1]).

In the following, a general overview of the architecture of the conditional invertible neural network model 212 is described. For further details, it is referred to reference[1].

The conditional invertible neural network model 212 may include five (deep) neural networks, s₁, t₁, s₂, t₂, and c. The conditional invertible neural network model 212 includes a uni-directional (viz. non-invertible) path 302. The other (upper and lower) paths of the conditional invertible neural network model 212 are invertible. Thus, illustratively, when being inverted, an output and a condition can be input into the (inverse path of the) conditional invertible neural network model 212 to determine a (new) input. Illustratively, the upper path and the lower path allow a flow in either direction. This is achieved by using invertible functional relationships between the outputs of the neural networks, s₁, t₁, s₂, and t₂, such as element-wise multiplication ⊙ and element-wise summation ⊕.

In the forward, non-inverted path, a respective input parameter value of each input parameter 206(n) of the plurality of input parameters 206 is input (as input) and a respective output parameter value of each output parameter 210(m) of the one or more output parameters 210 is input as condition into the conditional invertible neural network model 212. According to various aspects, the conditional invertible neural network model 212 is configured to generate a respective Shapley value 304(n) for each input parameter 206(n) of the plurality of input parameters 206 as output. Hence, the conditional invertible neural network model 212 may output a plurality of Shapley values 304, φ, (including a number of N Shapley values).

The input (viz. the respective input parameter value of each input parameter 206(n) of the plurality of input parameters 206) may be split into two parts, u₁ and u₂. The determination of the result, v₁, on the upper path and the result, v₂, on the lower path may be determined according to:

$${v}_{1} = {u}_{1} ⊙ exp ( {s}_{1} ( {u}_{2} ) ) + {t}_{1} ( {u}_{2} )$$

$${v}_{2} = {u}_{2} ⊙ exp ( {s}_{2} ( {v}_{1} ) ) + {t}_{2} ( {v}_{1} )$$

These results [v₁,v₂] may then be concatenated to determine the plurality of Shapley values 304.

When being inverted (viz. in inverted direction), the two parts, u₁ and u₂, may be determined by:

$${u}_{2} = ( {v}_{2} - {t}_{2} ( {v}_{1} ) ) exp ( {s}_{2} ( {v}_{1} ) )$$

$${u}_{1} = ( {v}_{1} - {t}_{1} ( {u}_{2} ) ) exp ( {s}_{1} ( {u}_{2} ) ) .$$

For further details on the architecture of the conditional invertible neural network model 212 it is referred to reference [1].

Shapley values have been introduced for multi-player game scenarios, wherein a Shapley value is determined for each player of a plurality of players and represents a contribution of the player to a result achieved by all players together. In the case of the technical system 200, the plurality of input parameters 206 are the players and the one or more output parameters 210 are the outcome resulting from an interplay of all those input parameters 206. Thus, each Shapley value 304(n) being associated with a corresponding input parameter 206(n) represent a contribution of the corresponding input parameter 206(n) in achieving the one or more output parameters 210.

Determining Shapley values is an NP-Hard problem that hardly scales in real-world applications. The standard formulas for Shapley value computation are either exponential (navigating the space of all sub-sets of players) or combinatorial (space of all orderings of players):

Exponential formula:

$${ϕ}_{i} = \frac{1}{\vert 𝒫 \vert} {\sum }_{𝒮 ⊆ ( 𝒫 \backslash \{ i \} )} {( \begin{matrix}\vert 𝒫 \vert - 1 \\ \vert 𝒮 \vert\end{matrix} )}^{- 1} ( v ( 𝒮 ⋃ \{ i \} - v ( 𝒮 ) )$$

where [symbol] is the set of all players (aka features or attributes in a model), [symbol] is a subset of players (excluding the target player i), and v(⋅) is the value/set function returning the reward of the game if played with a given set of players (e.g., performance of a machine learning model if only a particular subset of features is used as inputs).

### Combinatorial Formula:

$${ϕ}_{i} = \frac{1}{\vert 𝒫 \vert !} {\sum }_{R ∈ ℛ} ( v ( {P}_{i}^{R} ⋃ \{ i \} ) - v ( {P}_{i}^{R} ) )$$

where [symbol] is the set of all possible orderings of the players, and

$${P}_{i}^{R}$$

is the set of all players preceeding the i^{th} player in the ordering R.

In either case, exact computation of Shapley values is feasible only for very small number of system parameters (˜10 parameters) and does not scale for real-world needs.

According to various aspects, the conditional invertible neural network model 212 may be or may have been trained to predict (e.g., estimate) the Shapley values 304 responsive to inputting the plurality of input parameter values as input and the one or more output parameter values as condition. In particular, the conditional invertible neural network model 212 may have been trained using the following loss function:

$$ℒ ( θ ) = {𝔼}_{p ( x )} {𝔼}_{Unif ( y )} {𝔼}_{p ( s )} [ {( {υ}_{x , y} ( s ) - {υ}_{x , y} ( 0 ) - {s}^{T} {ϕ}_{fast} ( x , y ; θ ) )}^{2} ]$$

where θ are the model parameters, x is the model inputs (viz. the plurality of input parameters 206), y is the expected output (viz. in the Shapley values 304), s is a subset of features (and p(s) encodes the weight of that subset as given in the original Shapley formula), v_{x,y}(s) is the model output given only the feature subset s, and v_{x,y}(0) is the baseline value (the model's nominal prediction if no features were used), s^{T}φ_{fast}(x, y; θ) is the sum of the explainer's attributions to the given set of players/features.

The training of a neural network using this loss function is, for example, described in N. Jethani et al.: “FASTSHAP: REAL-TIME SHAPLEY VALUE ESTIMATION”, arXiv:2107.07436, 2022 (in the following referred to as reference [2]). It has been found that this loss function can be used to train the conditional invertible neural network model 212 since the dimensions of input and output are the same (since there is exactly one Shapley value for each input parameter). Using above loss function allows to reduce the computation cost for training the conditional invertible neural network model 212. With this loss function, the conditional invertible neural network model 212 can be trained to predict the Shapley values without the need to pre-compute them. For further details on how to use the above loss function it is referred to reference [2].

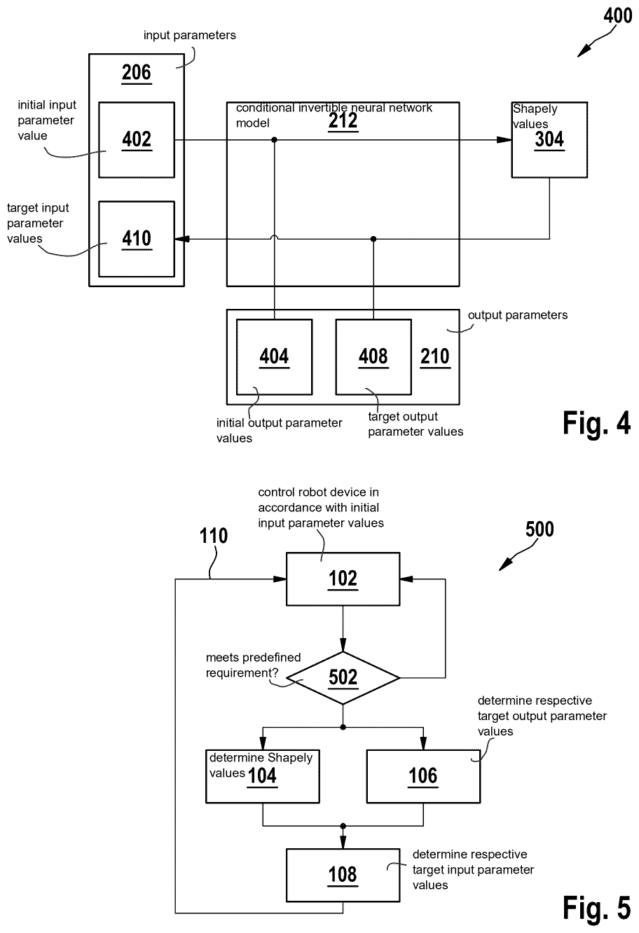

FIG. 4 shows a process flow of adapting the respective input parameter value 402(n) of each input parameter 206(n) of the plurality of input parameters 206 using the conditional invertible neural network model 212 according to various aspects.

As detailed herein, the controller 204 may (in 102) control the robot device 202 in accordance with a plurality of initial input parameter values 402 (with a respective initial input parameter value 402(n) for each input parameter 206(n) of the plurality of input parameter 206). And one or more initial output parameter values 404 (with a respective initial output parameter value 404(m) for each output parameter 210(m) of the one or more output parameters 210) (resulting from the plurality of input parameter values 402) may be detected (using the one or more sensors 208).

In 104, the plurality of initial input parameter values 402 may be input as input and the one or more initial output parameter values 404 as condition into the (forward path) of the conditional invertible neural network model 212 to determine the plurality of Shapley values 304.

Then, one or more target output parameter values 408 may be determined with a respective target output parameter 408 (m) for each output parameter 210(m) of the one or more output parameters 210. According to various aspects, the target output parameter value 408(m*) of at least one output parameter 210(m*) may be different from the initial parameter value 404(m*) of the at least one output parameter 210(m*).

In 108, the plurality of Shapley values 304 (or an adapted version thereof) (as output) and the one or more target output parameter values 408 (as condition) may be input into the inverse path of the conditional invertible neural network model 212 to determine a plurality of target input parameter values 410 (with a respective target input parameter value 410(n) for each input parameter 206(n) of the plurality of input parameters 206).

According to various aspects, one or more Shapley values of the plurality of Shapley values 304 may be adapted prior to inputting them into the inverse path of the conditional invertible neural network model 212.

For example, the one or more Shapley values may be adapted by changing their value to zero. As detailed herein, each Shapley value represents a contribution of the corresponding input parameter to the one or more output parameters. Thus, when changing its value to zero, the input parameter is considered as not having any contribution to the one or more output parameters. This results in that, when determining the plurality of target input parameter values 410, the input parameter value of the corresponding input parameter is not changed. Illustratively, the target input parameter value of the input parameter corresponding to the Shapley value then corresponds to the initial input parameter value. This allows to limit the adaption of the plurality of input parameters 206 to a limited subset thereof.

According to various aspects, the one or more Shapley values are a predefined number of smallest Shapley values (thereby adapting only the input parameters that have the greatest contribution to the one or more output parameters 210 and, therefore, require less change in its value(s).

According to various aspects, only the greatest Shapley value may be used and all other Shapley values may be changed to zero. This allows to achieve the one or more target output parameter values 408 by changing only one input parameter.

According to various aspects, the one or more target output parameter values 408 may be determined (e.g., only) in the case that it is determined that at least one of the initial output parameter values does not meet a predefined requirement (e.g., indicates a system failure).

FIG. 5 shows a flow diagram of a method 500 of managing system failures according to various aspects.

In 102, the technical system 200 may be controlled according to the plurality of initial input parameter values 402 and the output may be monitored (determining the one or more output parameter values 404).

The method 500 may include (in 502) for at least one (e.g., each) output parameter 210(m*) determining, whether the initial output parameter value 404(m*) of the at least one output parameter 210(m*) meets a predefined requirement (e.g., is within a predefined range).

In the case that it is determined, that the initial output parameter value 404(m*) of the at least one output parameter 210(m*) meets the predefined requirement (e.g., is within the predefined range), the method 500 may continue with step 102 (monitoring the technical system 200).

In the case that it is determined, that the initial output parameter value 404(m*) of the at least one output parameter 210(m*) does not meet the predefined requirement (e.g., is not within the predefined range), the method 500 may include (in 106) that the one or more target output parameter values 408 are determined by adapting the output parameter value of the at least one output parameter 210(m*) to meet the predefined requirement (e.g., to be within the predefined range).

In 104, the plurality of Shapley values 304 may be determined as detailed herein. Optionally, the plurality of Shapley values 304 may be employed to explain the observed one or more initial output parameter values 404 (e.g., by explaining the respective contribution of each input parameter 206(n)).

In 108, the plurality of Shapley values 304 (or the plurality of adapted Shapley values) and the one or more target output parameter values 408 may be input into the inverse path of the conditional invertible neural network model 212 to determine the plurality of target input parameter values 410. Then, (in 110) the robot device 202 may be controlled in accordance with the plurality of target input parameter values 410 and the output may be monitored again (in 102).

Illustratively, this method 500 allows to detect anomalies (e.g., system failures) and to determine adapt the input parameters such that the anomaly is overcome. Illustratively, the methods 100, 500 allow to bring the technical system 200 back to a desired (e.g., predefined) operational range.

The methods 100, 500 described herein allow to use any kind of input parameters since the conditional invertible neural network model 212 does not impose any data type limitations (such that the data type of the input parameters may be continuous, categorical, binary, etc.).

What is claimed is:

1. A method for controlling a robot device, the method comprising the following steps:
controlling the robot device in accordance with a respective initial input parameter value of each input parameter of a plurality of input parameters, and determining a respective initial output parameter value of each output parameter of one or more output parameters resulting from the controlling;
determining a plurality of Shapley values by inputting the respective initial input parameter value of each of the plurality of input parameters as input, and the respective initial output parameter value of each of the one or more output parameters as a condition into a conditional invertible neural network model, wherein each Shapley value of the plurality of Shapley values is associated with a corresponding input parameter of the plurality of input parameters and represents a contribution of the corresponding input parameter to the one or more output parameters;
determining a respective target output parameter value for each of the one or more output parameters, wherein the respective target output parameter value of at least one output parameter of the one or more output parameters is different from the respective initial output parameter value of the at least one output parameter;
determining a respective target input parameter value for each of the plurality of input parameters by inputting the plurality of Shapley values conditioned on the respective target output parameter value of each of the one or more output parameters into an inverse path of the conditional invertible neural network model; and
controlling the robot device in accordance with the respective target input parameter value of each of the plurality of input parameters.

2. The method according to claim 1, wherein each input parameter of the plurality of input parameters is a physical parameter, or a chemical parameter, or a control parameter.

3. The method according to claim 1, further comprising:
for at least one predefined output parameter of the one or more output parameters:
determining whether the respective initial output parameter value of the at least one predefined output parameter is within a predefined range; and
based on determining that the respective initial output parameter value of the at least one predefined output parameter is not within the predefined range, determining the respective target output parameter value of the at least one predefined output parameter to be within the predefined range.

4. The method according to claim 1, further comprising:
adapting the plurality of Shapley values prior to inputting the plurality of Shapely values into an inverse path of the conditional invertible neural network model, wherein the adapting of the plurality of Shapley values includes changing one or more Shapley values of the plurality of Shapley values to zero.

5. The method according to claim 4, wherein:
the one or more Shapley values are a predefined number of smallest Shapley values, or
the one or more Shapley values are all Shapley values of the plurality of Shapley values equal to or less than a threshold value.

6. The method according to claim 1, further comprising:
adapting the plurality of Shapley values prior to inputting the plurality of Shapely values into an inverse path of the conditional invertible neural network model, wherein the adapting of the plurality of Shapley values includes changing all Shapley values of the plurality of Shapley values except for a greatest Shapley value to zero.

7. A robot device controller configured to carry out a method for controlling a robot device, the method comprising the following steps:
controlling the robot device in accordance with a respective initial input parameter value of each input parameter of a plurality of input parameters, and determining a respective initial output parameter value of each output parameter of one or more output parameters resulting from the controlling;
determining a plurality of Shapley values by inputting the respective initial input parameter value of each of the plurality of input parameters as input, and the respective initial output parameter value of each of the one or more output parameters as a condition into a conditional invertible neural network model, wherein each Shapley value of the plurality of Shapley values is associated with a corresponding input parameter of the plurality of input parameters and represents a contribution of the corresponding input parameter to the one or more output parameters;
determining a respective target output parameter value for each of the one or more output parameters, wherein the respective target output parameter value of at least one output parameter of the one or more output parameters is different from the respective initial output parameter value of the at least one output parameter;
determining a respective target input parameter value for each of the plurality of input parameters by inputting the plurality of Shapley values conditioned on the respective target output parameter value of each of the one or more output parameters into an inverse path of the conditional invertible neural network model; and
controlling the robot device in accordance with the respective target input parameter value of each of the plurality of input parameters.

8. A technical system, comprising:
a robot device controller configured to carry out a method for controlling a robot device, the method including the following steps:
controlling the robot device in accordance with a respective initial input parameter value of each input parameter of a plurality of input parameters, and determining a respective initial output parameter value of each output parameter of one or more output parameters resulting from the controlling,
determining a plurality of Shapley values by inputting the respective initial input parameter value of each of the plurality of input parameters as input, and the respective initial output parameter value of each of the one or more output parameters as a condition into a conditional invertible neural network model, wherein each Shapley value of the plurality of Shapley values is associated with a corresponding input parameter of the plurality of input parameters and represents a contribution of the corresponding input parameter to the one or more output parameters,
determining a respective target output parameter value for each of the one or more output parameters, wherein the respective target output parameter value of at least one output parameter of the one or more output parameters is different from the respective initial output parameter value of the at least one output parameter,
determining a respective target input parameter value for each of the plurality of input parameters by inputting the plurality of Shapley values conditioned on the respective target output parameter value of each of the one or more output parameters into an inverse path of the conditional invertible neural network model, and
controlling the robot device in accordance with the respective target input parameter value of each of the plurality of input parameters;
the robot device; and
one or more sensors configured to acquire the respective initial output parameter value of each of the one or more output parameters.

9. A non-transitory computer-readable medium on which are stored instructions for controlling a robot device, the instructions, when executed by a computer, causing the computer to perform the following steps comprising:
controlling the robot device in accordance with a respective initial input parameter value of each input parameter of a plurality of input parameters, and determining a respective initial output parameter value of each output parameter of one or more output parameters resulting from the controlling;
determining a plurality of Shapley values by inputting the respective initial input parameter value of each of the plurality of input parameters as input, and the respective initial output parameter value of each of the one or more output parameters as a condition into a conditional invertible neural network model, wherein each Shapley value of the plurality of Shapley values is associated with a corresponding input parameter of the plurality of input parameters and represents a contribution of the corresponding input parameter to the one or more output parameters;
determining a respective target output parameter value for each of the one or more output parameters, wherein the respective target output parameter value of at least one output parameter of the one or more output parameters is different from the respective initial output parameter value of the at least one output parameter;
determining a respective target input parameter value for each of the plurality of input parameters by inputting the plurality of Shapley values conditioned on the respective target output parameter value of each of the one or more output parameters into an inverse path of the conditional invertible neural network model; and
controlling the robot device in accordance with the respective target input parameter value of each of the plurality of input parameters.
